(19) United States
(12) Patent Application Publication
(10) Pub. No.: US 2005/0232089 A1
(43) Pub. Date: Oct. 20, 2005

(54) Apparatus for reproducing information recorded in optical recording medium, and computer product

(75) Inventors: Hiroyuki Matsumoto, Kawagoe-shi (JP); Takeshi Matsumoto, Kawagoe-shi (JP); Katsunori Tamamura, Kawagoe-shi (JP); Takao Yoshida, Kawagoe-shi (JP); Fumito Inaba, Kawagoe-shi (JP); Morihiro Okamoto, Kawagoe-shi (JP)

Correspondence Address: FOLEY AND LARDNER;SUITE 500, 3000 K STREET NW, WASHINGTON, DC, 20007, US

(73) Assignee: PIONEER CORPORATION

(21) Appl. No.: 11/085,238

(22) Filed: Mar. 22, 2005

(30) Foreign Application Priority Data
Mar. 25, 2004 (JP) 2004-089644

(51) Int. Cl. G11B 7/085

(52) U.S. Cl. 369/30.1

(57) ABSTRACT

An apparatus for reproducing an optical recording medium includes a system controller. If a digital audio signal is present in a shockproof memory, the system controller sets a first search target address so as to be connected to an absolute time address of a digital audio signal which is last accumulated in the shockproof memory. If there is no digital audio signal in the shockproof memory, the system controller calculates a second search target address based on the absolute time address of the digital audio signal which is last accumulated in the shockproof memory and an elapsed time since no digital audio signal remains in the shockproof memory, and moves the optical pickup to a position on the disk indicated by the second search target address calculated.

### BACKGROUND OF THE INVENTION

1) Field of the Invention

The present invention relates to a technology for reproducing information recorded on an optical recording medium.

2) Description of the Related Art

Optical-recording-medium reproducing apparatuses reproduce information recorded on an optical recording medium (or disk) such as a laser disk, a compact disk, a mini disk, and a Digital Versatile Disk (DVD). Generally, the optical-recording-medium reproducing apparatuses irradiate a laser beam on the optical recording medium and read out the information recorded from the optical recording medium. When reading out the information, the optical-recording-medium reproducing apparatus follows tracks that are previously formed on the optical recording medium, and irradiates a laser beam thereon, but sometimes cannot follow the track due to a shock and the like. More specifically, the laser beam sometimes jumps over the track called track jump due to the shock, and information is read out from a position to which the laser beam jumps. If the information recorded on the optical recording medium is audio data, and if the audio data read-out is subjected to a demodulation process and is outputted as it is, a dropout occurs due to the track jump. Particularly, if the optical-recording-medium reproducing apparatus is a portable type or is installed in vehicles, the dropout frequently occurs due to shocks.

To improve the problem, an optical-recording-medium reproducing apparatuses usually include a shockproof memory that accumulates digital audio signals for a predetermined time. More specifically, the optical-recording-medium reproducing apparatus reads out audio data recorded on the optical recording medium, performs a demodulation process and an error correction process on the audio data read-out so as to generate a digital audio signal that is a reproduction signal, and accumulates the digital audio signal in the shockproof memory. When the digital audio signal accumulated is to be outputted and reproduced, the optical-recording-medium reproducing apparatus reads out the audio data from the optical recording medium at a speed faster than a speed at which the digital audio signal is outputted from the shockproof memory, and generates a digital audio signal. In other words, the optical-recording-medium reproducing apparatus pre-reads out audio data, and accumulates a digital audio signal generated from the audio data in the shockproof memory, and outputs the digital audio signal accumulated. With this configuration, when the track jump occurs, there is an extra time for reading out audio data again that continues to the last digital audio signal accumulated in the shockproof memory.

However, a problem still occurs when the optical recording medium is scratched or soiled. In such a case, audio data at this location of the optical recording medium cannot be read out, and therefore, the track jump may frequently occur, which causes the shockproof memory to become empty of digital audio signals accumulated. In other words, when the optical recording medium is scratched or soiled, audio data at this location cannot be read out, but this is different from the case where the track jump occurs due to the shock. During repetition of reading the audio data, all the digital audio signals accumulated in the shockproof memory are outputted and the shockproof memory becomes empty, which results in interruption of sound.

In order to resolve the problem, Japanese Patent Application Laid-Open No. Hei 8-249820 discloses a technology for continuing reproduction of the audio data. In this conventional technology, if the shockproof memory becomes empty of the digital audio signals accumulated, an absolute time address is calculated by adding a fixed amount a of time to a final address before a track jump occurs, the fixed amount a of time being such that it does not give unnatural feeling to a listener. The optical pickup for irradiating a laser beam on the optical recording medium is moved to the address position calculated, and audio data is read out from the address position to continue reproduction.

In the conventional technology, if there is no digital audio signal left in the shockproof memory, audio data is read out from the absolute time address obtained in the above manner. Therefore, if the scratch or the soil on the optical recording medium is small, a dropout may occur only once so that it can be negligible for the listener who is listening to sound, and reproduction can be continued thereafter.

However, the conventional technology still has some problems. For example, if the scratch or the soil on the optical recording medium is large and the audio data cannot be read out even from the absolute time address obtained by adding the fixed amount α of time to the final address before the track jump occurs, the audio data is repeatedly read out from the same address (the absolute time address obtained by adding the fixed amount α of time to the final address before the track jump occurs), and a silent state continues.

In order to avoid reading data from the same address, for example, in the conventional technology, it may be possible to add the fixed amount α not to the final address before the track jump occurs but to the absolute time address. However, if the final address before occurrence of the track jump is set as an initial value, and if an absolute time address is calculated by repeating addition of the fixed amount α until the audio data can be read out, some problems may occur. For example, because the absolute time address is shifted by each fixed amount α in the above case, there is a displacement from an output time of a digital audio signal generated originally by reading out the audio data. More specifically, a displacement occurs between the output time of the digital audio signal generated when the audio data is successfully read out and the output time of the digital audio signal generated from the audio data that is read out from an absolute time address calculated through addition of the fixed amount α. This problem causes the listener to have unnatural feeling especially when he or she is humming to music being reproduced.

### SUMMARY OF THE INVENTION

It is an object of the present invention to solve at least the problems in the conventional technology.

According to one aspect of the present invention, an apparatus for reproducing audio data recorded in an optical recording medium includes an optical pickup, a storage unit, a reproduction processor, a system controller, and a reproducing unit. The optical pickup reads out the audio data from the optical recording medium. The storage unit accumulates at least one of a plurality of first digital audio signals obtained by performing a demodulation process on the audio data read-out. The reproduction processor executes a reproduction process with respect to the audio data, the reproduction process including performing the demodulation process, generating a second digital audio signal, which is to be stored in the storage unit, from the audio data at a speed faster than a speed at which the first digital audio signal is outputted from the storage unit, and outputting the first digital audio signal from the storage unit. The system controller sets a first search target address so that a first absolute time address and a second absolute time address are consecutive if the first digital audio signal is present in the storage unit, the first absolute time address being indicated by one of the plurality of first digital audio signals which is last accumulated in the storage unit, and the second absolute time address being indicated by a digital audio signal which is generated from the audio data to be read-out by the optical pick up, causes the optical pickup to read out audio data from the first search target address set, calculates a second search target address, if there is no first digital audio signal in the storage unit, based on the first absolute time address and an elapsed time since no digital audio signal is present in the storage unit, and causes the optical pickup to read out audio data from the second search target address calculated. The reproducing unit reproduces audio data based on the first digital audio signal.

According to another aspect of the present invention, when an apparatus includes an optical pickup that reads out the audio data from the optical recording medium, and a storage unit that stores at least one of a plurality of first digital audio signals obtained by performing a demodulation process on the audio data read-out, the method including generating a second digital audio signal from the audio data at a speed faster than a speed at which the first digital audio signal is output from the storage unit, a method, for the apparatus, of reproducing audio data recorded in an optical recording medium includes setting a first search target address so that a first absolute time address and a second absolute time address are consecutive if the first digital audio signal is present in the storage unit, the first absolute time address being indicated by one of the plurality of first digital audio signals which is last accumulated in the storage unit, and the second absolute time address being indicated by a digital audio signal which is generated from the audio data to be read-out by the optical pickup; causing the optical pickup to read out audio data from the first search target address set; calculating a second search target address, if there is no first digital audio signal in the storage unit, based on the first absolute time address and an elapsed time since no first digital audio signal is present in the storage unit; and causing the optical pickup to read out audio data from the second search target address calculated.

According to still another aspect of the present invention, a computer-readable recoding medium stores therein a computer program for controlling a reproduction of audio data recorded in an optical recording medium. The computer program is for an apparatus for reproducing the audio data from the optical recording medium. The apparatus includes an optical pickup that includes a laser light source for emitting a laser beam and an objective lens for irradiating the laser beam on the optical recording medium, and reads out audio data recorded on the optical recording medium by the laser beam guided by the objective lens; and a storage unit that accumulates at least one of a plurality of first digital audio signals obtained by performing a demodulation process on the audio data read-out from the optical recording medium. The program is for generating a second digital audio signal from the audio data at a speed faster than a speed at which the first digital audio signal is output from the storage unit. The program causes a computer to execute monitoring and determining whether the first digital audio signal is present in the storage unit; measuring time if it is determined that no first digital audio signal is present in the storage unit; buffering including calculating a first search target address so that a first absolute time address and a second absolute time address are consecutive if it is determined that the first digital audio signal is present in the storage unit, the first absolute time address being indicated by one of the plurality of the first digital audio signals which is last accumulated in the storage unit, and the second absolute time address being indicated by a digital audio signal which is generated from the audio data read-out by the optical pickup; and calculating a second search target address, if it is determined that there is no first digital audio signal in the storage unit, based on the first absolute time address and the time measured; and causing the optical pickup to read out audio data from the second search target address calculated.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an optical-recording-medium reproducing apparatus according to the present invention;

FIG. 2 is a block diagram of a system controller of FIG. 1;

FIG. 3 is a flowchart for explaining operation of the optical-recording-medium reproducing apparatus;

FIG. 4 is a timing chart for explaining operation of the optical-recording-medium reproducing apparatus.

### DETAILED DESCRIPTION

Exemplary embodiments of the present invention are explained in detail below with reference to the accompanying drawings.

Optical-recording-medium reproducing apparatuses, which reproduce a disk with audio data recorded thereon, usually include a shockproof memory to prevent a dropout. The optical-recording-medium reproducing apparatus including the shockproof memory reads out audio data from the disk at a speed faster than a speed at which audio data is reproduced, for example, a speed twice as fast as the speed at which the audio data is reproduced. The optical-recording-medium reproducing apparatus performs a predetermined process on the audio data read-out so as to generate a digital audio signal, accumulates the digital audio signal in the shockproof memory, and outputs the digital audio signal accumulated in the shockproof memory. In other words, the audio data is pre-read out from the disk, and digital audio signals for a predetermined time, which follow digital audio signals currently outputted, are accumulated in the shockproof memory. With this accumulation, even if an error occurs in reading from the disk due to a shock and the like, a dropout is prevented since the digital audio signals accumulated in the shockproof memory are outputted.

The present invention is provided for a case as follows. There is the case where all the digital audio signals accumulated in a shockproof memory are read out because audio data recorded on an optical recording medium cannot be read out due to the scratch or the soil on the optical recording medium. In this case, audio data at a position of a search target address is read out. The search target address is obtained by adding an elapsed time after the time when a digital audio signal is read out from the shockproof memory, to an absolute time address of the digital audio signal last accumulated in the shockproof memory.

More specifically, if no digital audio signal is present in the shockproof memory, the search target address is decided so as to generate a digital audio signal after an actual time is elapsed from a digital audio signal last output. Therefore, even if the audio data cannot be read out from the optical recording medium due to the scratch or the soil thereon, a laser beam can jump over the scratch or the soil at such a timing that does not interrupt how the listener feels when listening to sound being reproduced, which allows reproduction of the optical recording medium to be continued without any unnatural feeling given to the listener.

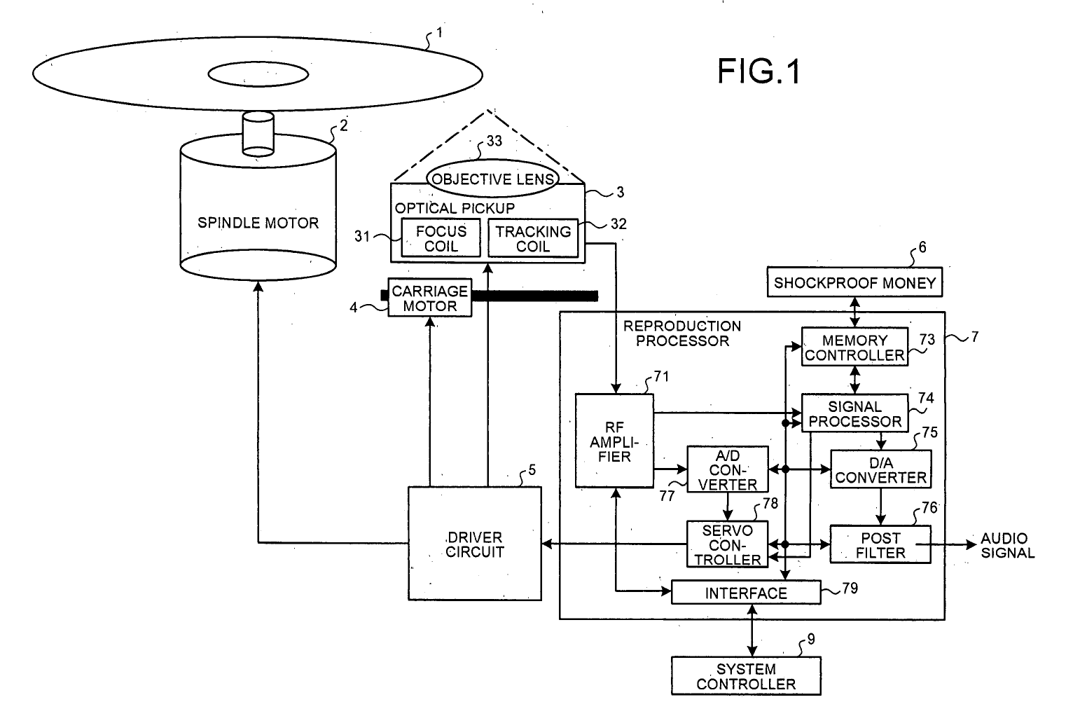

An embodiment of the present invention is explained below with reference to FIG. 1 to FIG. 4. FIG. 1 is a schematic of an optical-recording-medium reproducing apparatus according to the embodiment of the present invention. The optical-recording-medium reproducing apparatus includes a spindle motor 2, an optical pickup 3, a carriage motor 4, a reproduction processor 7, a driver circuit 5, a shockproof memory 6, and a system controller 9. The spindle motor 2 rotates a disk 1, the optical pickup 3 irradiates a laser beam on the disk 1 and reads out information from the disk 1, and the carriage motor 4 drives the optical pickup 3 in a tracking direction of the disk 1 (a diametric direction of the disk 1). The reproduction processor 7 generates a digital audio signal based on audio data read-out from the disk 1 by the optical pickup 3, outputs the digital audio signal generated, and generates various servo signals for driving a focus coil 31 and a tracking coil 32 in the optical pickup 3, the carriage motor 4, and the spindle motor 2 by servo control. The driver circuit 5 amplifies a current of each servo signal generated by the reproduction processor 7 and outputs drive signals for driving the focus coil 31, the tracking coil 32, the carriage motor 4, and the spindle motor 2. The shockproof memory 6 (which corresponds to a storage unit in claims) temporarily stores the digital audio signal generated by the reproduction processor 7, and the system controller 9 integrally controls the optical-recording-medium reproducing apparatus.

The optical pickup 3 includes a semiconductor laser (not shown) that serves as a light source of a laser beam, an objective lens 33 for an optical system, a liquid crystal panel (not shown), an optical detector (not shown) that detects light reflected from the disk 1, the focus coil 31, and the tracking coil 32. In the optical pickup 3, the light source emits a laser beam, the laser beam irradiated on the disk 1 through the liquid crystal panel and the objective lens 33, the optical detector detects the light reflected from the disk 1, the light reflected is converted to an electrical signal, and the electrical signal is outputted to a Radio Frequency (RF) amplifier 71 of the reproduction processor 7.

The focus coil 31 drives the objective lens 33 according to a focus drive signal inputted from the driver circuit 5, and focuses the laser beam to be irradiated on the disk 1. The tracking coil 32 drives the objective lens 33 in the tracking direction of the disk 1 according to a tracking drive signal inputted from the driver circuit 5.

The reproduction processor 7 includes the RF amplifier 71, a signal processor 74, a memory controller 73, a digital-to-analog (D/A) converter 75, a post filter 76, an analog-to-digital (A/D) converter 77, a servo controller 78, and an interface 79.

The RF amplifier 71 performs operation and amplification on electrical signals inputted from the optical pickup 3, and generates an RF signal, a focus error signal, and a tracking error signal from the electrical signals operated and amplified. The RF amplifier 71 binarizes the RF signal generated and outputs the RF signal binarized to the signal processor 74.

The signal processor 74 generates a Constant Linear Velocity (CLV) error signal used for constant linear velocity of the spindle motor 2 according to the RF signal binarized, and outputs the CLV error signal to the servo controller 78. The signal processor 74 performs an Eight-to-Fourteen Modulation (EFM) demodulation process on the RF signal binarized, and performs an error-correction demodulation process and the like on a demodulation signal using Cross Interleave Reed-Solomon Code (CIRC) so as to generate a digital audio signal. The signal processor 74 outputs the digital audio signal generated to the memory controller 73, and outputs the digital audio signal inputted from the memory controller 73 to the D/A converter 75.

The memory controller 73 includes a function of controlling access to the shockproof memory 6, stores the digital audio signal inputted from the signal processor 74 in the shockproof memory 6, reads out the digital audio signal stored from the shockproof memory 6, and outputs the digital audio signal read-out to the signal processor 74. Furthermore, the memory controller 73 extracts a sub-code including information such as an absolute time address from the digital audio signal to be stored in the shockproof memory 6 and the digital audio signal read-out from the shockproof memory 6, and outputs the sub-code extracted to the system controller 9.

The D/A converter 75 converts the digital audio signal inputted from the signal processor 74 to an analog audio signal, and outputs the analog audio signal obtained through conversion to the post filter 76. The post filter 76 removes a noise component from the analog audio signal, and outputs an audio signal in an audio frequency band.

The A/D converter 77 converts an analog focus error signal and an analog tracking error signal inputted from the RF amplifier 71 to digital values, and outputs a digital focus error signal and a digital tracking error signal to the servo controller 78.

The servo controller 78 generates a spindle servo signal based on the CLV error signal. The servo controller 78 generates a carriage servo signal for driving the carriage motor 4 and a tracking servo signal for driving the tracking coil 32 based on the tracking error signal. The servo controller 78 generates a focus servo signal for driving the focus coil 31 based on the focus error signal. The servo controller 78 outputs the spindle servo signal, the carriage servo signal, the tracking servo signal, and the focus servo signal to the driver circuit 5.

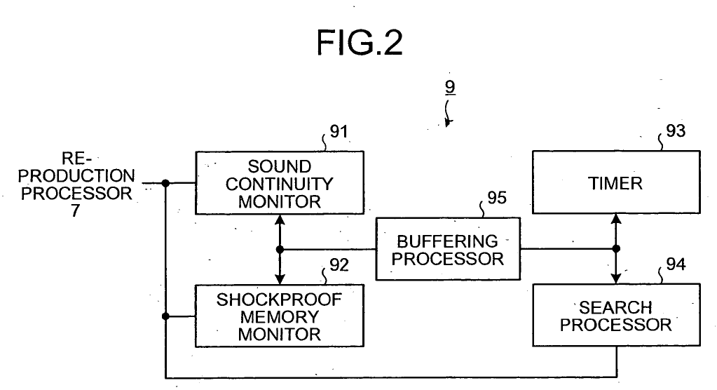

FIG. 2 is a block diagram of the system controller 9 of FIG. 1. The system controller 9 includes a sound continuity monitor 91, a shockproof memory monitor 92 (which corresponds to a data monitoring unit in claims), a timer 93, a search processor 94, and a buffering processor 95.

The sound continuity monitor 91 extracts an absolute time address (total elapsed time) from Q information of sub-code extracted by the signal processor 74, and determines whether the audio data read-out from the disk 1 has continuity (whether a track jump does not occur). The sound continuity monitor 91 displays a display time on a display panel (not shown) based on the absolute time address extracted from the Q information of the sub-code of the digital audio signal that is outputted. Furthermore, if the track jump occurs, the sound continuity monitor 91 notifies the buffering processor 95 of occurrence of the track jump and of the absolute time address, as a search target address, of the audio information last accumulated in the shockproof memory 6.

The shockproof memory monitor 92 accesses the memory controller 73 through the interface 79 to monitor how the shockproof memory 6 is used, i.e., an accumulation amount of the digital audio signals accumulated in the shockproof memory 6. When detecting that there is no area for accumulation of the digital audio signals in the shockproof memory 6 (“memory full”), the shockproof memory monitor 92 notifies the buffering processor 95 and the timer 93 of “memory full”. When detecting that there is an area for accumulation of the digital audio signals in the shockproof memory 6, the shockproof memory monitor 92 notifies the buffering processor 95 that accumulation becomes possible. Furthermore, when detecting that there is no digital audio signal accumulated in the shockproof memory 6, the shockproof memory monitor 92 notifies the buffering processor 95 and the timer 93 of “memory empty”. When receiving the notification of “memory empty”, the timer 93 starts measuring the time, and finishes measuring the time when receiving the notification of “memory full”.

The search processor 94 notifies the servo controller 78, through the interface 79, of a search target address, with which sound continuity should be performed, outputted by the buffering processor 95, and moves the optical pickup 3 to a position on the disk 1 indicated by the search target address.

When receiving the notification of “memory empty”, the buffering processor 95 calculates a search target address based on the absolute time address that is extracted from the Q information of the sub-code of the digital audio signal and inputted from the sound continuity monitor 91 and based on the time measured by the timer 93, and outputs the search target address calculated to the search processor 94.

When receiving the notification of “memory full”, the buffering processor 95 calculates a search target address based on the absolute time address that is extracted from the Q information of the sub-code of the digital audio signal and inputted from the sound continuity monitor 91, and outputs the search target address calculated to the search processor 94. When receiving the notification of “track jump”, the buffering processor 95 calculates a search target address based on the absolute time address that is extracted from the Q information of the sub-code of the digital audio signal and inputted from the sound continuity monitor 91, and outputs the search target address calculated to the search processor 94.

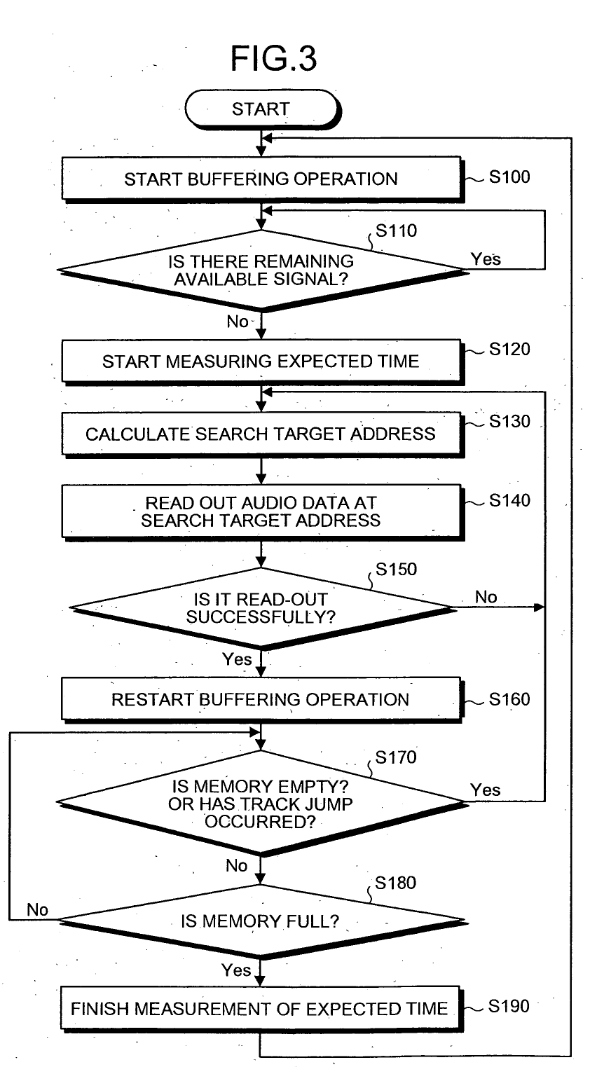

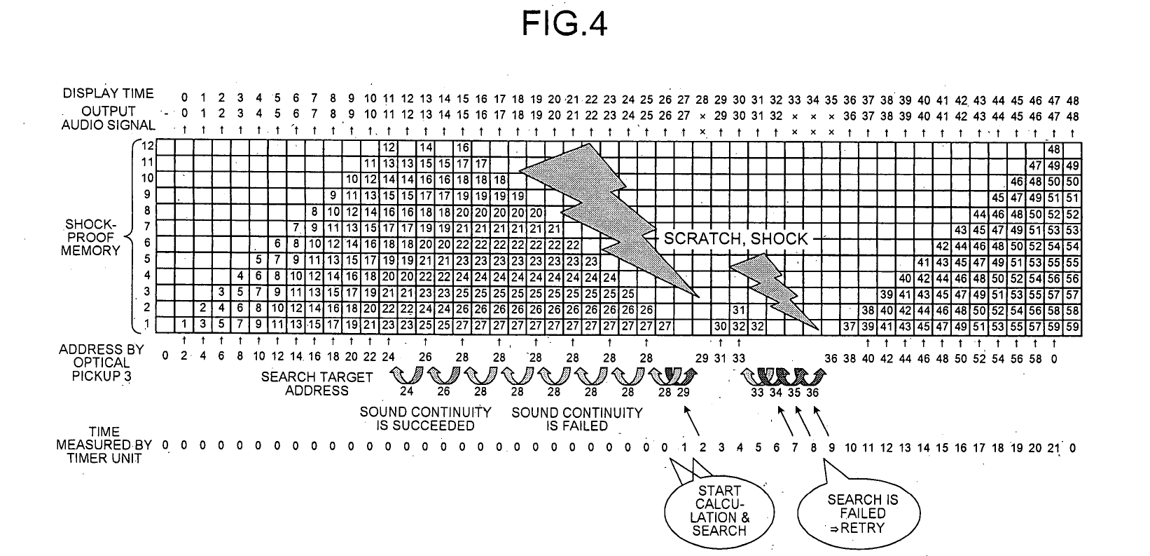

Operation of the optical-recording-medium reproducing apparatus according to the embodiment is explained below with reference to a flowchart of FIG. 3 and a timing chart of FIG. 4. A speed at which audio data 1T (T is one unit time for reading) is read out is set to twice as fast as a speed at which a digital audio signal is outputted, and a digital audio signal to be accumulated in the shockproof memory 6 is set as an amount for 12 T.

The buffering processor 95 causes the components of the reproduction processor 7 to operate through the search processor 94, and start buffering operation of reading out audio data recorded on the disk 1 by the optical pickup 3, generating a digital audio signal from the audio data read-out, and accumulating the digital audio signal generated in the shockproof memory 6 (step S100). More specifically, when detecting that a reproduction instruction of the disk 1 is inputted into the optical-recording-medium reproducing apparatus, the buffering processor 95 notifies the servo controller 78, through the search processor 94, so as to move the optical pickup 3 to a position on the disk 1 indicated by the absolute time address in a header of a frame to be reproduced on the disk 1. Furthermore, the buffering processor 95 instructs the components of the reproduction processor 7 to perform the reproduction process. With this instruction, the servo controller 78 outputs the spindle servo signal, the carriage servo signal, the tracking servo signal, and the focus servo signal, and makes the spindle motor 2 rotate through the driver circuit 5. Furthermore, the servo controller 78 moves the optical pickup 3 to the absolute time address in the header of the frame to be reproduced of the disk 1 by the carriage motor 4, and starts reading the audio data recorded on the disk 1.

The RF amplifier 71 generates an RF signal from the signal inputted from the optical pickup 3. The signal processor 74 performs the EFM demodulation process on the RF signal so as to generate a demodulation signal, and performs the error-correction demodulation process or the like on the demodulation signal using the CIRC so as to generate a digital audio signal.

The memory controller 73 stores the digital audio signal generated in the shockproof memory 6 and reads out the digital audio signal generated from the shockproof memory 6, and the D/A converter 75 converts the digital audio signal to an analog audio signal. The post filter 76 removes a noise component from the analog audio signal, and outputs the analog audio signal without the noise component, and sound output is started so that a listener can listen to it.

The servo controller 78 controls the rotational speed of the spindle motor 2 so as to read out audio data from the disk 1 at a speed, for example, twice as fast as a speed at which the digital audio signal is outputted. Therefore, as shown in FIG. 4, at display time 0T, audio data at absolute time addresses “0” and “1” are read-out to generate two digital audio signals, and the digital audio signal for the absolute time address “0” is outputted, and audio information for the absolute time address “1” is stored in the shockproof memory 6. At display time 1T, while audio data at absolute time addresses “2” and “3” are read-out to generate two digital audio signals, the digital audio signal for the absolute time address “1” accumulated in the shockproof memory 6 at display time 0T is outputted, and audio information for the absolute time addresses “2” and “3” is accumulated in the shockproof memory 6.

If such operation is repeated and if no track jump occurs during the repetition, the shockproof memory 6 becomes “memory full” at display time 11T. When detecting that “memory full” occurs, the shockproof memory monitor 92 notifies the buffering processor 95 of “memory full”.

When receiving the notification of “memory full”, the buffering processor 95 notifies the reproduction processor 7 of stopping the process of reading out audio data. With this notification, the reproduction processor 7 stops the process of reading out the audio data from the disk 1, and executes only the operation of outputting the digital audio signal read-out from the shockproof memory 6. This allows the shockproof memory 6 to have an empty area. As shown in FIG. 4, at the display time 11T, if the digital audio signals for 12T from an absolute time address “12” to an absolute time address “23” are accumulated in the shockproof memory 6, the shockproof memory monitor 92 outputs notification of “memory full” to the buffering processor 95, and the buffering processor 95 notifies the reproduction processor 7 of stopping the process of reading the audio data. At display time 12T, the digital audio signal for the absolute time address “12” in the shockproof memory 6 is outputted, and an empty area for 1T is formed in the shockproof memory 6. When detecting the empty area, the shockproof memory monitor 92 notifies the buffering processor 95 that accumulation becomes possible.

The sound continuity monitor 91 notifies the buffering processor 95 of the absolute time address “23” of the audio information last accumulated in the shockproof memory 6. The buffering processor 95 sets a search target address to “24” because the absolute time address last notified by the sound continuity monitor 91 is “23”. In other words, since the reading of the audio data is stopped once, the search target address that is supposed to be set to “26” is corrected to “24” with which the search target address continues to the digital audio signal that is last accumulated in the shockproof memory 6. The buffering processor 95 notifies the servo controller 78 of the search target address “24” through the search processor 94, and also notifies the reproduction processor 7 of restarting the process of reading the audio data. With this notification, at display time 13T, audio data at absolute time addresses “24” and “25” on the disk 1 are read-out to generate digital audio signals. The digital audio signals for the absolute time address “24” and “25” are accumulated in the shockproof memory 6, and the digital audio signal for an absolute time address “13” is outputted. More specifically, the two digital audio signals for the absolute time addresses “24” and “25” are accumulated next to the digital audio signal for the absolute time address “23” in the shockproof memory 6, and sound continuity is performed successfully.

If the shockproof memory 6 is full, the reading of the audio data is stopped in the above manner, while if the shockproof memory 6 has an empty area, such operation as follows is repeated. That is, audio data at an absolute time address, as a search target address, that is next to the digital audio signal last accumulated in the shockproof memory 6 is read out, and a digital audio signal is generated from the audio data read-out. Then, the digital audio signal generated is accumulated in the shockproof memory 6.

At display time 16T, the search target address is set to “28” and reading of audio data is tried to be restarted, but a track jump occurs due to a shock, or a scratch or soil on the disk 1. An absolute time address “27” of the audio information last accumulated in the shockproof memory 6 is notified to the buffering processor 95 from the sound continuity monitor 91. Since the absolute time address last notified by the sound continuity monitor 91 is “27”, the buffering processor 95 outputs “28” as a search target address to the search processor 94. The search processor 94 notifies the reproduction processor 7 so as to read out the audio data at the search target address “28”. However, because the track jump occurs due to the scratch or the soil on the disk 1, the audio data at the search target address “28” cannot be read out (sound continuity is failed). During repetition of reading the audio data from the search target address “28”, the digital audio signals stored in the shockproof memory 6 is decreasing. At display time 27T, by outputting the digital audio signal for a search target address “27”, the shockproof memory 6 becomes empty of the digital audio signals accumulated. In other words, the shockproof memory 6 has no remaining available signal.

The shockproof memory 6 always monitors the shockproof memory 6 and determines whether there is any remaining available signal (step S110). If it is detected that there is no remaining available signal, the shockproof memory monitor 92 notifies the buffering processor 95 and the timer 93 of “memory empty”.

When receiving the notification of “memory empty”, the timer 93 starts measuring time (measuring an expected time) (step S120). The timer 93 outputs the time measured to the buffering processor 95.

The buffering processor 95 adds the time measured by the timer 93 to an absolute time address (“27” in this case) of the digital audio signal last accumulated in the shockproof memory 6 to calculate a search target address (step S130). More specifically, an address at which audio data at the expected time is recorded is set as a search target address, and the address is outputted to the search processor 94. The expected time indicates an actual time elapsed from a time when the digital audio signal is last outputted.

The search processor 94 notifies the servo controller 78 of the search target address outputted from the buffering processor 95. With the notification, the servo controller 78 moves the optical pickup 3 to a position on the disk 1 indicated by the search target address notified, and the optical pickup 3 reads out audio data (step S140).

The buffering processor 95 adds the time measured by the timer 93 to the absolute time address of the digital audio signal last accumulated in the shockproof memory 6 to calculate a search target address, and outputs it to the search processor 94. A series of these operations are repeated until the audio data is read-out successfully (step S130 to step S150).

As shown in FIG. 4, at display time 27T, by outputting the digital audio signal for the absolute time address “27”, the shockproof memory 6 becomes empty of the remaining available signal. The shockproof memory monitor 92 outputs the notification of “memory empty” to the timer 93, and the timer 93 starts measuring the time. The buffering processor 95 obtains the search target address “28” by adding the time “1T” measured to the absolute time address “27” of the digital audio signal that is last outputted, and outputs the search target address “28” to the search processor 94.

The search processor 94 notifies the servo controller 78 of the search target address outputted by the buffering processor 95. With this notification, the servo controller 78 moves the optical pickup 3 to a position on the disk 1 indicated by the search target address notified.

However, if no audio data is read out even at display time 28T, it is indicated that there is no remaining digital audio signal to be outputted, which results in a silent state. Although the display times are continuously displayed in FIG. 4 for explanation, actually, no display time is displayed on the display panel during the silent state. The buffering processor 95 obtains a search target address “29” by adding the time “2T” measured by the timer 93 to the absolute time address “27” of the digital audio signal that is last outputted, and notifies the search processor 94 of the search target address “29”. With this notification, at display time 29T, the optical pickup 3 is moved to a position with the search target address “29”, and audio data is read out from the search target address “29”.

If the audio data is read out successfully, a digital audio signal is generated from the audio data read-out, and the buffering operation of accumulating the digital audio signal generated in the shockproof memory 6 is restarted (step S160).

The buffering processor 95 continues calculation of a search target address obtained by adding time measured by the timer 93 to an absolute time address of a digital audio signal upon reception of the notification of “memory empty”. The calculation is continued during the time from restarting the buffering operation to receiving the notification of “memory full” from the shockproof memory monitor 92 after the shockproof memory 6 becomes full (step S130 to step S180).

Referring to FIG. 4, the audio data is read out successfully at display time 29T, and a digital audio signal generated from the audio data at an absolute time address “29” is outputted. Furthermore, a digital audio signal generated from audio data at an absolute time address “30” is stored in the shockproof memory 6.

At display time 30T, audio data at absolute time addresses “31” and “32” are read out, and two digital audio signals are generated therefrom to be accumulated in the shockproof memory 6, and the digital audio signal generated from the audio data at the absolute time address “30” is outputted.

However, if a track jump occurs due to a shock, or a scratch or soil on the disk 1 and if reading of audio data is continued to be unsuccessful, the shockproof memory 6 becomes empty of the remaining available signal at display time 32T. Therefore, the shockproof memory monitor 92 outputs notification of “memory empty” to the buffering processor 95. When receiving the notification, the buffering processor 95 obtains a search target address by adding the time measured. by the timer 93 to the absolute time address (absolute time address “27” in this case) of the digital audio signal obtained upon initial reception of the notification of “memory empty”, and outputs the search target address obtained to the search processor 94. These operations are repeated until audio data at the search target address is read out successfully, and during these operations (display times 33T to 35T), the silent state is continued (the display time during silence is not outputted on the display panel).

At display time 36T, the audio data is read out successfully, and thereafter, the buffering operation is continued without occurrence of any track jump. At display time 47T, the shockproof memory 6 becomes full. When detecting that the shockproof memory 6 becomes full, the shockproof memory monitor 92 outputs notification of “memory full” to the timer 93 and the buffering processor 95.

When receiving the notification, the timer 93 finishes measurement of the time (measurement of the expected time) (step S190). When the timer 93 finishes measurement of the time, the buffering processor 95 returns to the buffering operation based on an absolute time address of audio data that is set as a search target address and notified by the sound continuity monitor 91. The audio data is next to the audio data last accumulated in the shockproof memory 6.

In the embodiment, the shockproof memory monitor 92 monitors the accumulation amount of digital audio signals in the shockproof memory 6, and outputs notification of “memory empty” to the timer 93 and the buffering processor 95 when there is no digital audio signal in the shockproof memory 6. When receiving the notification, the timer 93 starts measuring time, and the buffering processor 95 calculates a search target address by adding the time measured by the timer 93 to the absolute time address of the digital audio signal that is inputted from the sound continuity monitor 91 and is last outputted. The optical pickup 3 is moved to a position on the disk indicated by the search target address, and audio data at the position is read out. With these operations, even if the audio data cannot be read out from the optical recording medium due to a scratch or soil on the disk, the optical pickup 3 can jump over the scratch or the soil at such a timing that does not interrupt how the listener feels when listening to sound being reproduced, which allows reproduction of the optical recording medium to be continued without any unnatural feeling given to the listener.

In the embodiment, the search target address is continued to be calculated based on the time measured by the timer 93 and the absolute time address of the digital audio signal that is last outputted during the time from no presence of digital audio signal in the shockproof memory 6 to “memory full” therein. But, it may be continued to be calculated till audio data at the search target address is read out successfully and a predetermined amount of digital audio signals is accumulated.

In the embodiment, although the audio data is read out at a speed twice as fast as a speed at which the digital audio signal is outputted, the speed at which the audio data is read out is not limited to the speed, but the present invention requires at least a speed faster than the speed at which the digital audio signal is outputted.

The reproduction processor 7 is generally controlled by a Central Processing Unit (CPU) in many cases. The functions to be performed by the sound continuity monitor 91, the shockproof memory monitor 92, the timer 93, and the search processor 94 may be realized by software and may be executed by the CPU that controls the reproduction processor 7.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An apparatus for reproducing audio data recorded in an optical recording medium, the apparatus comprising:
an optical pickup that reads out the audio data from the optical recording medium;
a storage unit that accumulates at least one of a plurality of first digital audio signals obtained by performing a demodulation process on the audio data read-out;
a reproduction processor that executes a reproduction process with respect to the audio data, the reproduction process including performing the demodulation process, generating a second digital audio signal, which is to be stored in the storage unit, from the audio data at a speed faster than a speed at which the first digital audio signal is outputted from the storage unit, and outputting the first digital audio signal from the storage unit;
a system controller that
sets a first search target address so that a first absolute time address and a second absolute time address are consecutive if the first digital audio signal is present in the storage unit, the first absolute time address being indicated by one of the plurality of first digital audio signals which is last accumulated in the storage unit, and the second absolute time address being indicated by a digital audio signal which is generated from the audio data to be read-out by the optical pick up,
causes the optical pickup to read out audio data from the first search target address set,
calculates a second search target address, if there is no first digital audio signal in the storage unit, based on the first absolute time address and an elapsed time since no digital audio signal is present in the storage unit, and
causes the optical pickup to read out audio data from the second search target address calculated; and
a reproducing unit that reproduces audio data based on the first digital audio signal.

2. The apparatus according to claim 1, wherein the system controller includes
a data monitoring unit that monitors an accumulation amount of the first digital audio signals accumulated in the storage unit, and outputs a memory-empty notification that indicates the storage unit is empty, when no first digital audio signal is present in the storage unit;
a timer unit that starts measuring time upon receiving the memory-empty notification;
a sound-continuity monitoring unit that extracts a third absolute time address from a sub-code of the first digital audio signal accumulated in the storage unit; and
a buffering processor that
sets a value, as a third search target address, obtained by adding the time measured to the third absolute time address extracted when receiving the memory-empty notification,
sets a fourth absolute time address, as a fourth search target address, that continues to the third absolute time address extracted by the sound continuity monitoring unit when receiving no memory-empty notification, and
causes the optical pickup to read out audio data from either one of the third search target address and the fourth search target address.

3. The apparatus according to claim 2, wherein
the data monitoring unit outputs a memory-full notification that indicates the storage unit is full, when the first digital audio signals are stored in an entire storage area of the storage unit;
the timer unit finishes measurement of the time upon receiving the memory-full notification from the data monitoring unit; and
the buffering processor sets a value, as a fifth search target address, obtained by adding the time measured by the timer unit to the third absolute time address extracted by the sound continuity monitoring unit, during a time from reception of the notification of “memory-empty” until reception of the memory-full notification.

4. A method of reproducing audio data recorded in an optical recording medium, the method for an apparatus that includes an optical pickup that reads out the audio data from the optical recording medium, and a storage unit that stores at least one of a plurality of first digital audio signals obtained by performing a demodulation process on the audio data read-out, the method including generating a second digital audio signal from the audio data at a speed faster than a speed at which the first digital audio signal is output from the storage unit, the method comprising:
setting a first search target address so that a first absolute time address and a second absolute time address are consecutive if the first digital audio signal is present in the storage unit, the first absolute time address being indicated by one of the plurality of first digital audio signals which is last accumulated in the storage unit, and the second absolute time address being indicated by a digital audio signal which is generated from the audio data to be read-out by the optical pickup;
causing the optical pickup to read out audio data from the first search target address set;
calculating a second search target address, if there is no first digital audio signal in the storage unit, based on the first absolute time address and an elapsed time since no first digital audio signal is present in the storage unit; and
causing the optical pickup to read out audio data from the second search target address calculated.

5. A computer-readable recoding medium that stores therein a computer program for controlling a reproduction of audio data recorded in an optical recording medium, the computer program for an apparatus for reproducing the audio data from the optical recording medium, wherein
the apparatus includes
an optical pickup that includes a laser light source for emitting a laser beam and an objective lens for irradiating the laser beam on the optical recording medium, and reads out audio data recorded on the optical recording medium by the laser beam guided by the objective lens; and
a storage unit that accumulates at least one of a plurality of first digital audio signals obtained by performing a demodulation process on the audio data read-out from the optical recording medium,
the program is for generating a second digital audio signal from the audio data at a speed faster than a speed at which the first digital audio signal is output from the storage unit, and
the program causes a computer to execute:
monitoring and determining whether the first digital audio signal is present in the storage unit;
measuring time if it is determined that no first digital audio signal is present in the storage unit;
buffering including
calculating a first search target address so that a first absolute time address and a second absolute time address are consecutive if it is determined that the first digital audio signal is present in the storage unit, the first absolute time address being indicated by one of the plurality of the first digital audio signals which is last accumulated in the storage unit, and the second absolute time address being indicated by a digital audio signal which is generated from the audio data read-out by the optical pickup; and
calculating a second search target address, if it is determined that there is no first digital audio signal in the storage unit, based on the first absolute time address and the time measured; and
causing the optical pickup to read out audio data from the second search target address calculated.
